(19) United States
(12) Patent Application Publication
(10) Pub. No.: US 2024/0281695 A1
(43) Pub. Date: Aug. 22, 2024

(54) FAULT TOLERANT QUANTUM COMPUTATION IN SPIN SYSTEMS USING CAT CODES

(71) Applicants: UNM Rainforest Innovations, Albuquerque, NM (US); Alphabet Inc., Mountain View, CA (US)

(72) Inventors: Milad Marvian Mashhad, Albuquerque, NM (US); Ivan Deutsch, Albuquerque, NM (US); Sivaprasad Omanakuttan, Albuquerque, NM (US); Sri Datta Vikas Buchemmavari, Albuquerque, NM (US); Jonathan A. Gross, Albuquerque, NM (US)

(21) Appl. No.: 18/441,924

(22) Filed: Feb. 14, 2024

Related U.S. Application Data
(60) Provisional application No. 63/484,873, filed on Feb. 14, 2023.

(51) Int. Cl. G06N 10/70; G06N 10/20

(52) U.S. Cl. CPC G06N 10/70; G06N 10/20

(57) ABSTRACT

A set of quantum error correcting codes for spin systems providing a path to fault tolerance with fewer qubits by using the extra available internal degrees of freedom. Cat codes in the spin system are used which are the equal superpositions of stretched states, with consideration of errors that are products of angular momentum and not just restricted to linear in angular momentum operators.

### REFERENCE TO RELATED APPLICATIONS

This application claims the benefit of U.S. Provisional Patent Application No. 63/484,873 filed Feb. 14, 2023.

### FEDERALLY SPONSORED RESEARCH AND DEVELOPMENT

This invention was made with government support under CCF-2237356 awarded by the National Science Foundation and 2016244 awarded by the Quantum Leap Challenge Institutes. The government has certain rights in the invention.

### FIELD OF THE INVENTION

The invention relates to fault-tolerant quantum computation. More specifically, the invention relates to quantum error-correcting codes for spin systems.

### BACKGROUND OF THE INVENTION

Quantum computers that perform quantum computation are difficult to build because the qubits used to make them are unstable. Qubits are distinguished by superposition, or the ability to be both 0 and 1 at the same time, while traditional data bits are either 0 or 1. Increasing the capacity of the units that are performing the calculations can be achieved by qudits, which have a number of possible states greater than 2.

Fault-tolerant quantum computation is essential for implementing quantum computation reliably and accurately. In fault-tolerant quantum computation, the goal is to use faulty unreliable physical gates to perform reliable computation. In fault-tolerant quantum computation, the logical states are encoded in a larger Hilbert space, followed by logical gates such that the information is protected against certain dominant errors in the physical system. In fault-tolerant quantum computation, the goal is to use faulty unreliable physical gates to perform reliable computation. The threshold theorem states that it is possible to perform an arbitrary quantum computation provided the error rate per physical gate or time step is below some constant threshold value.

While the overhead required to make a computation fault-tolerant scales sub-linearly in the system-size, experimental implementations of fault-tolerant quantum computation have substantial hurdles to overcome. There has been significant progress in recent years in this direction, but further improvements are needed.

One of the natural ways to think about fault-tolerant quantum computation is to encode a logical qubit in multiple physical qubits followed by well-designed logical gates. The error model commonly considered is the depolarizing error model where there is an equal probability for all the single Pauli errors. This model does not assume any structure for the errors and considers all the errors equally and these codes come at the cost of demanding threshold requirements and large overheads. Despite this difficulty, these techniques are widely considered for QEC. There has been progress in its implementation, including recent experimental implementation using the surface codes and color codes.

Another approach for error correction is to look for error-correcting codes that incorporate the fact that some noise processes are more probable than others. These kinds of “error-biased” codes have improved the threshold for fault tolerance and may reduce the total number of physical qubits to encode the logical qubit. One approach is encoding qubits of a harmonic oscillator which are used in the “continuous variable” quantum computation. In the physical implementation one error dominates over the others. For example, in bosonic qubits using cat qubits, where the probability of Z error is exponentially more than the X, Y errors. Another approach converts the major errors into erasure errors, and this significantly improves the threshold required for fault tolerance.

A code may be generated which corrects for the native errors for a qubit encoded in a spin system, where the natural errors are the form of angular momentum operators (Jx ,Jy, Jz), the generators of SU(2) rotations—the spin of particles corresponding to their behavior under spatial rotations. However, there may be errors from higher-order angular momentum operators from processes such as optical pumping which are dominant in atomic spin systems. Also, the syndrome measurement of these codes is not easily implemented, and this creates a hindrance to using these codes for fault-tolerant quantum computation.

Thus, there is a need to design codes that correct for errors associated with higher order angular momentum operators so that all relevant errors are corrected in these physical systems by using the available internal higher dimension and thus substantially reduce the total number of physical systems required for fault tolerance. The invention satisfies this need.

### SUMMARY OF THE INVENTION

The invention is directed to a new set of quantum error correcting codes for spin systems motivated by the recent developments in continuous-variable quantum codes using cat codes and progress in neutral-atom computing. The cat codes are used in the spin system which are the equal superpositions of magnetic sublevels (the “stretched states”) along a desired axis. Such spin cat states can be created experimentally with high fidelity. Errors that are products of angular momentum are considered, not just those restricted to linear in angular momentum operators. The method provides protection against errors generated by polynomials of the spin angular momentum operators. These error generators represent different physical error processes.

The simple encoding of the spin cat codes puts the errors into two categories: phase errors and amplitude damping errors. The basic cat encoding naturally protects against amplitude damping up to a certain level. To correct for phase errors a code using employing the technique of concatenation is used.

The implementation of the universal gate set is also provided. The key ingredients for the universal gate set are the fault-tolerant preparation of the cat state and a CX gate that preserves correctable errors. There are multiple ways of creating high-fidelity initial preparation of the cat state including using optimal control protocols and one-axis twisting interaction. As for the CX gate, a scheme is developed for quantum computing with neutral alkaline earth atoms. The protocol makes use of auxiliary excited-state energy levels with high lifetime. These schemes can be extended to quantum computing with other atomic elements, e.g., alkali atoms, as well as using the hyperfine states as the auxiliary state.

After the universal gate set is developed, the syndrome measurements to correct errors is developed. The syndrome measurement for phase errors are easy to obtain. The syndrome measurement for the amplitude error is fundamentally harder to implement, however, the correction of this error does not depend on the concatenation of cat codes. To correct amplitude errors, the higher dimensional nature of a qubit is used along with a SWAP gate approach. This SWAP gate approach is used in other schemes as well where the major source of error is leakage of the population to a space outside the computational space.

The threshold for the error correction code developed here is estimated to be higher than the general schemes of error correction. Also, the correction of the amplitude damping error allows for very low logical errors once the error rate is lower than the threshold for fault tolerance.

An object of the invention is to reduce the required overhead using a set of quantum error correcting codes developed from a collection systems, each with a large spin in which quantum information is encoded.

### BRIEF DESCRIPTION OF DRAWINGS

FIG. 1 illustrates a schematic of the qubit encoded in a qudit using the cat states |+ [symbol] and |i [symbol] with the state |0 [symbol] analogous to the coherent state from the continuous variable setting called the stretched state.

FIG. 2 illustrates a target density matrix, adiabatic approach, and quantum control scheme.

FIG. 3 illustrates a protocol for creating bias preserving CNOT gate.

FIG. 4 illustrates the piecewise constant approach to finding the Π gate that transforms the population from the meta-stable manifold to the Rydberg manifold. The total time of the evolution is 4π/Ωrf divided into 12 equal time steps.

FIG. 5 illustrates Bloch sphere evolution for the independent evolution of the ground and the excited state.

FIG. 6 illustrates the basis circuit that transfers to start decoding the state α|+>+β|−>.

FIG. 7 illustrates the gadget including the error correction steps for both the phase and the amplitude damping errors.

FIG. 8 illustrates the different curves showing results from the number of physical qubits used with the intersection of the different curves indicating the threshold for universal quantum computation.

### DETAILED DESCRIPTION OF THE INVENTION

In bosonic systems, cat qubits have been considered as a potential candidate for error correcting codes, these codes are naturally resistant to amplitude damping errors. These ideas are exported to spin systems where a qubit could be encoded into concatenated spin cat codes where the cat codes naturally protect against angular momentum errors/amplitude errors up to some order and concatenation is used to correct phase errors. This approach generalizes to a large class of physical systems including semiconductor qubits, ion traps, atomic systems, molecules, and superconducting systems including those with a lot of internal degrees of freedom.

To generalize cat codes for continuous variable systems, such as spin systems, a cat state is defined as the quantum superposition of two coherent states. The positive and negative cat states are defined

$$\vert {C}_{α}^{\pm } 〉 ∝ \vert α 〉 \pm \vert - α 〉 , \qquad ( 1 )$$

where |α [symbol] is a coherent state.

The generalizations of the cat-state also known as GHZ state, for a collection of qubits. Similarly, one can consider a qudit system where the states are defined as

$$\vert 0 〉 = \vert J , {J}_{z} = J 〉 ≡ \vert {J}_{z} = J 〉 \qquad ( 2 )$$

$$\vert 1 〉 = \vert J , {J}_{z} = - J 〉 ≡ \vert {J}_{z} = - J 〉 . \qquad ( 3 )$$

which are stretched states with maximum projection along the z axis (the choice of the axis is arbitrary, and defined it along z for convenience). These states are analogous to the coherent state for qudits also known as spin coherent state and one could construct a family of these states by acting SU(2) operators on these states. However, unlike the continuous variable setting the states are orthogonal to one another. Now the spin cat states for a qudit is given as

$$\vert \pm 〉 = \frac{1}{\sqrt{2}} ( \vert 0 〉 \pm \vert 1 〉 ) . \qquad ( 4 )$$

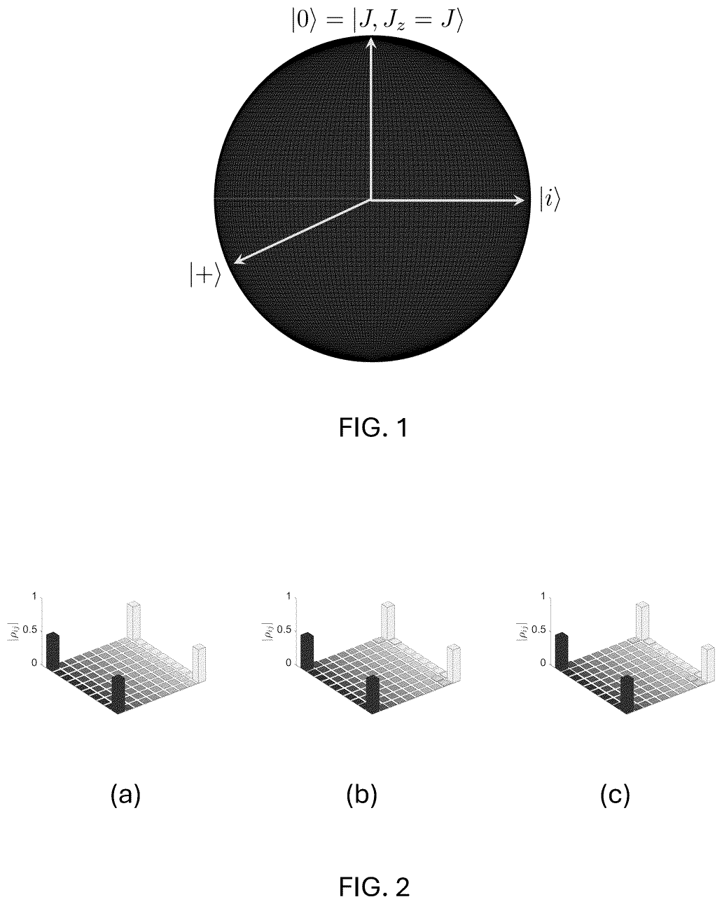

The schematic of the cat state-based qubit is given in FIG. 1. The cat states protect against a certain degree of amplitude damping which takes a state |J,J_{z}=J [symbol] →|J,J_{z}=J−1 [symbol] and |J,J_{z}=−J [symbol] →|J,J_{z}=−J+1 [symbol] but not sufficient to protect against phase errors |J_{z}=±J [symbol] →e^{±iθ}|J_{z}=±J [symbol] . Now a concatenation approach is used to correct for both amplitude and phase errors such that

$$\vert {+}_{L} 〉 = \vert + 〉 \vert + 〉 \vert + 〉 , \qquad ( 5 )$$

$$\vert {-}_{L} 〉 = \vert - 〉 \vert - 〉 \vert - 〉 .$$

These can be considered as a generalized version of the Shor code as

$${{{\vert {0}_{ES} 〉 = \frac{1}{\sqrt{8}} ( \vert 0 〉}^{⊗ 2 J + 1} + \vert 1 〉}^{⊗ 2 J + 1} )}^{{⊗}^{3}} \qquad ( 6 )$$

$${{{\vert {1}_{ES} 〉 = \frac{1}{\sqrt{8}} ( \vert 0 〉}^{⊗ 2 J + 1} - \vert 1 〉}^{⊗ 2 J + 1} )}^{{⊗}^{3}}$$

Similar to the Shor code the inner layer corrects for amplitude damping whereas the outer layer protects against bit flips. A similar approach studied in the bosonic system provides improved threshold values for fault tolerance compared to the standard approaches.

To characterize the dominant error channels the correctable errors are considered for a qubit encoded in a spin j system for the cat encoding. One way to understand the correctable set of errors is to study the Knill-Laflamme conditions

$$〈 {ψ}_{i} \vert {E}_{a}^{†} {E}_{b} \vert {ψ}_{j} 〉 = {C}_{ab} {δ}_{ij} , \qquad ( 7 )$$

where i,j={0,1} and |ψi [symbol] represents the code space of interest. The set of discrete errors considered here are the powers of angular momentum up to some rank K

$${ε}_{K} = \{ {J}_{x}^{l} {J}_{y}^{m} {J}_{z}^{n} ; 0 \leq l , m , n \leq K ; s . t max ( l + m + n ) = K \} . \qquad ( 8 )$$

To account for this, the angular momentum errors are considered which are more natural to the spin systems. Now Eq. (7) can be used for the error channels in Eq. (8). At first one can consider the following part of the Knill-Laflamme conditions

$$\begin{matrix}< {ψ}_{i} \vert {E}_{a}^{†} {E}_{b} \vert {ψ}_{j} >= 0 & ∀ i \neq j\end{matrix} \qquad ( 9 )$$

Considering the code words in Eq. (5) (with {|0_{L} [symbol] , |1_{L} [symbol] }) and using the locality assumption of errors, where the errors are occurring only in one of the physical systems, it is straightforward to see

$$〈 {0}_{L} \vert {E}_{a}^{†} {E}_{b} \vert {1}_{L} 〉 = 0 = 〈 {1}_{L} \vert {E}_{a}^{†} {E}_{b} \vert {0}_{L} 〉 , \qquad ( 10 )$$

for all the error channels described in the Eq. (8). Now consider the second part of Knill-Laflamme conditions. It is desired to prove that

$$〈 {0}_{L} \vert {E}_{a}^{†} {E}_{b} \vert {0}_{L} 〉 = 〈 {1}_{L} \vert {E}_{a}^{†} {E}_{b} \vert {1}_{L} 〉 . \qquad ( 11 )$$

Considering the errors of the form, Jₓ^{k}J_{y}^{l}⊗1⊗1, where k,l are positive integers, and using the property that

$$\vert \pm > = \frac{1 \pm exp ( i π {J}_{y} )}{\sqrt{2}} \vert {J}_{z} = J > \qquad ( 12 )$$

the condition translates into a much simpler form

$$< {0}_{L} \vert {J}_{x}^{k} {J}_{y}^{l} ⊗ 1 ⊗ 1 \vert {0}_{L} >= {1}_{L} {J}_{x}^{k} {J}_{y}^{l} ⊗ 1 ⊗ 1 \vert {1}_{L} > \qquad ( 13 )$$

using Eq. (11) one can simplify the constraint such that the condition one need to satisfy is

$${J}_{z} = < - J \vert {J}_{x}^{k} {J}_{y}^{l} \vert {J}_{z} = J >= {J}_{z} = < J \vert {J}_{x}^{k} {J}_{y}^{l} \vert {J}_{z} = - J >= 0. \qquad ( 14 )$$

Now using the fact that

$${J}_{x} = \frac{{J}^{+} + {J}^{-}}{2} , \qquad ( 15 )$$

$${J}_{y} = \frac{{J}^{+} - {J}^{-}}{2 i}$$

2J−1 operations J⁺ or J⁻ operators are needed to have a nonzero overlap between the states |J,J_{z}=J> and |J,J_{z}=−J>. Thus the error of weight (2J−1)/2 for the angular momentum operators can be corrected using this platform. Considering an error of the form Jₓ^{k}J_{y}^{l}⊗Jₓ^{k}′J_{y}^{l}′⊗1, the above arguments can be used to see that all the errors can be corrected when 0≤k+l, k′+l′≤(2J−1)/2. Intuitively, each of the |J_{z}=J> and |J_{z}=−J> can accommodate some errors such that there is a limit of change in the value of J_{z}, after which the state is no longer useful. This value is (2J−1)/2 which is slightly less than the half the total number of accessible states in a system with spin J.

Now consider parity-preserving errors such that, exp(−iπJ_{z})Eₐ⁵⁵⁴E_{b}exp(iπJ_{z})=Eₐ⁵⁵⁴E_{b} which in turn gives

$$< \overline{0 \vert} {E}_{a}^{†} {E}_{b} \vert \overline{0} >= \overline{0} exp ( i π {J}_{z} ) {E}_{a}^{†} {E}_{b} exp ( - i π {J}_{z} ) \vert \overline{0} > . \qquad ( 16 )$$

However, it is easy to see that for the codes under construction exp(−iπJ_{z})|0̅>=i|1̅> and hence

$$< \overline{0 \vert} {E}_{a}^{†} {E}_{b} \vert \overline{0} > = < \overline{1 \vert} {E}_{a}^{†} {E}_{b} \vert \overline{1} > . \qquad ( 17 )$$

Then, the error correction criteria can be translated to the following few criteria

$${E}_{a}^{†} {E}_{b} = exp ( - i π {J}_{z} ) {E}_{a}^{†} {E}_{b} exp ( i π {J}_{z} ) \qquad ( 18 )$$

$${J}_{x}^{k} {J}_{y}^{l} ∀ k + l \leq 2 J - 1 .$$

From the Knill-Laflamme conditions errors described by irreducible tensors on the spin up to rank K can be corrected. This indicates that gates need to be employed that does not take the errors from a rank ≤K to rank >K. One way to ensure this is to use gates U that belong to SU(2) such that

$$U {ε}_{K} {U}^{†} ∈ {ε}_{K} \qquad ( 19 )$$

However, for the Hadamard gate H defined by the transitions

$$H \vert 0 > = \vert + > \qquad ( 20 )$$

$$H \vert 1 > = \text{\textbar -} > ,$$

$$then$$

$$U {ε}_{K} {U}^{†} ∉ {ε}_{K} . \qquad ( 21 )$$

Hence the Hadamard is not a good gate to consider in the universal gate set. One possible universal gate set is

$$\{ {P}_{\vert {0}_{L} >} , {P}_{\vert + {>}_{L}} , {ℳ}_{{x}_{L}} , {ℳ}_{{z}_{L}} , {CX}_{L} \} ⋃ \{ {P}_{\vert {i}_{L} >} , {P}_{\vert {T}_{L} >} \} , \qquad ( 22 )$$

where the L denote logical operators, P denotes state preparation, and [symbol] are the measurement operator for a given observable. The first set along with the magic state |i>=(|0>_{L}+i|1>_{L}/\sqrt{2} provides the full gate set of Clifford gates whereas the magic state |T>=(|0>_{L}+e^{-iπ/4}|1>_{L}/\sqrt{2} provides the necessary non-Clifford part of the computation to complete the universal gate set. The magic states can be created by remaining in the correctable error using ZZ(θ) gates.

A large set of gates can be found using the SU(2) rotation, which is easy to implement. For example, the Pauli gates are

$$X = exp ( - i π {J}_{x} ) , \qquad ( 23 )$$

$$Y = exp ( - i π {J}_{y} ) ,$$

$$Z = exp ( - i π {J}_{z} ) .$$

Similarly an SU(2) version of the T and S gate is defined as

$$T = exp ( - i \frac{π}{8} \frac{{J}_{z}}{j} ) , \qquad ( 24 )$$

$$S = exp ( - i \frac{π}{4} \frac{{J}_{z}}{j} ) .$$

An important step is to prepare the state the spin cat state, |+ [symbol] =(|J [symbol] +|−J [symbol] )/\sqrt{2} with high accuracy There are multiple approaches that can be used to prepare |+ [symbol] from |0 [symbol] . The first approach considered is based on the Hamiltonian

$$H ( s ) = ( 1 - s ) {J}_{x} - \frac{s}{2 j} \text{?} \qquad ( 25 )$$

$$\text{?} \text{indicates text missing or illegible when filed}$$

Adiabatic evolution starting with even parity will end up with the even parity cat state. The second approach is to use the idea of quantum control to create the target state using the controllable Hamiltonian

$$H ( t ) = {Ω}_{rf} ( cos [ c ( t ) π ] {J}_{x} + sin [ c ( t ) π ] {J}_{y} ) + β {J}_{z}^{2} , \qquad ( 26 )$$

Also, with one-axis twisting such that there is a time-independent Hamiltonian, H=BJₓ² and if is run for a time T=π/(2β), a rotational equivalent is produced of the cat state |+

[symbol]

$$\vert + 〉 = exp ( - i π {J}_{x} ) exp ( - i \frac{π}{2} \text{?} ) \vert J , {J}_{x} = J 〉 \qquad ( 27 )$$

$$\text{?} \text{indicates text missing or illegible when filed}$$

Now, a specific example is considered based on neutral atom quantum computing. A natural error process is optical pumping due to atoms' absorbing laser light used for control, followed by spontaneous emission. The effects of decoherence are modeled in the state preparation protocols using the Lindblad Master equation. Considering ⁸⁷Sr atoms and using a tensor light shift to create the Jₓ² term required for the Hamiltonian, then

$$\frac{d ρ [ c , t ]}{dt} = - {iH}_{eff} [ c ] ρ [ c , t ] + Γ {\sum }_{i} {W}_{q} ρ [ c , t ] {W}_{q}^{†} ≡ ℒ [ c ] [ ρ [ c , t ] ] . \qquad ( 28 )$$

where the jump operators for optical pumping between magnetic sublevels describing absorption followed by emission of a q-polarized photon are W_{q}

$${W}_{q} = {\sum }_{{F}^{′}} \frac{Ω / 2}{{Δ}_{{FF}^{′}} + i Γ / 2} ( {e}_{q} \cdot {D}_{{FF}^{′}} ) ( {\vec{ϵ}}_{L} \cdot {D}_{{FF}^{′}}^{†} ) . \qquad ( 29 )$$

Here D_{FF′}^{†} are the dimensionless dipole raising operators from ground state manifold F=I to the excited state manifold F′, H_{eff}[c]=H[c]−iΓΣ_{q}W_{q}^{†}W_{q}/2 is the non-Hermitian control Hamiltonian.

Using this error model, the cat state is created with a fidelity of 0.9998 for the one axis twisting and 0.9993 using quantum control and 0.9889 for the adiabatic preparation and the plot of the density matrices—the target as well as the one obtained using the adiabatic as well as quantum control approaches and the resultant density matrix and is visualized using the absolute value of the elements of the density matrix as shown in FIG. 2.

A CNOT gate is developed that preserves the characteristic bias of the noise targeted. A CNOT is a quantum logic gate that is an essential component in the construction of a gate-based quantum computer. The usual schemes of creating CZ gate and applying the Hadamard is not viable because using Hadamard will convert a correctable error to an uncorrectable error.

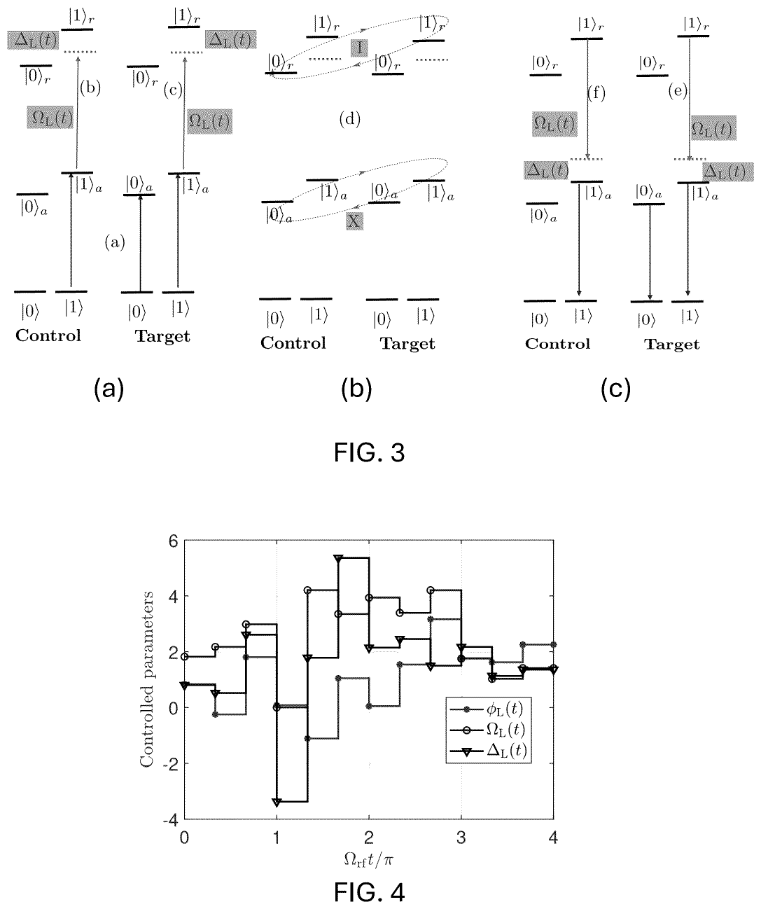

In FIG. 3, the protocol for creating the CNOT with only SU(2) operation is given as a 7-step process. The idea is to use the metastable state available for 87Sr. The information encoded in the ground state is first promoted to the metastable state. The metastable used according to one embodiment is one of the “clock states” of 87Sr with a large hyperfine manifold.

In the first step (a), the population is promoted to the metastable state. For the control atom, only the population of the |1 [symbol] state is promoted to the metastable state. For the target atom, both the population from |0 [symbol] and |1 [symbol] are promoted to the metastable state. Now in step (b), a π-pulse is applied between the metastable (m) and the Rydberg (ryd) state by which one could promote the population in |1 [symbol] ms→|1 [symbol] ryd. In step (c) a π-pulse is applied to the target atom. However, due to the Rydberg blockade, the population will only transfer from the metastable to the Rydberg state of the target atom if the control atom is in the |0 [symbol] and if the state of the control atom was |1 [symbol] , this transition is blockaded. In (d), an X gate is implemented in the metastable state and the identity operator elsewhere. Thus, if the state of the control atom is in |1 [symbol] , an X gate is applied to the target atom, otherwise the target atom is unchanged. This is the desired action of CNOT gate. In (e) the population is transferred from the Rydberg state of the target state back to the metastable state and in (f) the same is done for the control atom. In the last step (g) the population from the metastable states is transferred back to the ground state.

To implement a bias-preserving CNOT gate, a pulse must be implemented which takes the population from the metastable state to the Rydberg state. However, the population needs to be transferred from all of the sublevels in the ground subspace to the excited subspace. To do this optimal control can be used. The target unitary transformation is

$${U}_{tar} = {\sum }_{i = - j}^{j} {\vert}^{3} {P}_{2} , F = \frac{9}{2} , {m}_{F} = i 〉 {〈}^{3} {S}_{1} \vert , F = \frac{11}{2} , {m}_{F} = i \vert + c . c . \qquad ( 30 )$$

where, |5s²,³S₁,

$$F = \frac{11}{2} >$$

is the chosen Rydberg state. Control is considered based on a modulated laser excitation. Assuming π-polarized light, the Hamiltonian between the metastable and Rydberg state is

$${H}_{L} ( t ) = {\sum }_{i = - j}^{j} - {Δ}_{L} ( t ) \vert {r}_{i} 〉 〈 {r}_{i} \vert + {Ω}_{L} ( t ) [ cos ( {ϕ}_{L} ( t ) ) {σ}_{x}^{i} + sin ( {ϕ}_{L} ( t ) ) {σ}_{y}^{i} ] \qquad ( 31 )$$

where |rᵢ>=|5s²,³S₁,

$$F = \frac{11}{2} ,$$

m_{F}=i> and

$${σ}_{x}^{i} = \vert {r}_{i} 〉 {〈}^{3} {P}_{2} , F = \frac{9}{2} , {m}_{F} = i \vert + c . c , \qquad ( 32 )$$

$${σ}_{y}^{i} = - i \vert {r}_{i} 〉 {〈}^{3} {P}_{2} , F = \frac{9}{2} , {m}_{F} = i \vert + c . c .$$

the parameters Φ(t)={Ω_{L}(t), Δ_{L}(t), Φ_{L}(t)} are optimized using the cost function defined as

$$ℱ [ Φ ( t ) ] = \frac{1}{{( 2 j + 1 )}^{2}} {\vert [ {U}_{tar}^{†} U ( Φ ( t ) ) ] \vert}^{2} \qquad ( 33 )$$

with U(Φ(t))= [symbol] [exp(−i∫₀^{T}H[Φ(t)]dt)]. For example the piecewise constant approach for the above is given in FIG. 4.

An X gate may be implemented in the metastable manifold without doing anything in the Rydberg manifold. This is accomplished by taking advantage of the different g-factors for the Rydberg manifold and ground manifold. For the specific choice of auxiliary and Rydberg manifold, g_{ryd}/gₐ=2 is chosen and hence the application of time-dependent magnetic field will give the following Hamiltonians for these manifolds

$${H}_{a} ( t ) = {Ω}_{rf} ( cos ( ω t ) {J}_{x} + sin ( ω t ) {J}_{y} ) + {ω}_{0} {J}_{z} , \qquad ( 34 )$$

$${H}_{ryd} ( t ) = 2 {Ω}_{rf} ( cos ( ω t ) {J}_{x} + sin ( ω t ) {J}_{y} ) + 2 {ω}_{0} {J}_{z} .$$

The factors of 2 that appear in the Rydberg manifold arise solely due to the different g factors. Now using ω=4/3ω₀ and going the rotating frame with the unitary U=exp(−iωt) the Hamiltonian in rotating frame is

$${H}_{ms}^{rf} ( t ) = {Ω}_{rf} ( cos ( ϕ ( t ) ) {J}_{x} + sin ( ϕ ( t ) ) {J}_{y} ) - 1 / 3 ( {ω}_{0} ) {J}_{z} \qquad ( 35 )$$

$${H}_{ryd}^{rf} ( t ) = 2 {Ω}_{rf} ( cos ( ϕ ( t ) ) {J}_{x} + sin ( ϕ ( t ) ) {J}_{y} ) + 2 / 3 ( {ω}_{0} ) {J}_{z}$$

Thus, the effective Rabi frequency of the metastable manifold is

$${Ω}_{ms}^{eff} = \sqrt{{Ω}_{rf}^{2} + \frac{{ω}_{o}^{2}}{9}} . \qquad ( 36 )$$

$$and$$

$${Ω}_{ms}^{eff} = \sqrt{{Ω}_{rf}^{2} + \frac{{ω}_{o}^{2}}{9}} . \qquad ( 37 )$$

Thus, the ground manifold rotates with half the Rabi frequency as the Rydberg manifold and this simple fact helps in creating arbitrary unitary in the metastable and Rydberg manifold.

When ω₀=3Ω_{rf} and an X gate in the metastable manifold with I in the Rydberg manifold by a piecewise constant function with steps where \vec{Φ}=[−π/2, π/2] with a total time is given as

$${T}_{tot} = \frac{\sqrt{2} π}{{Ω}_{rf}} . \qquad ( 38 )$$

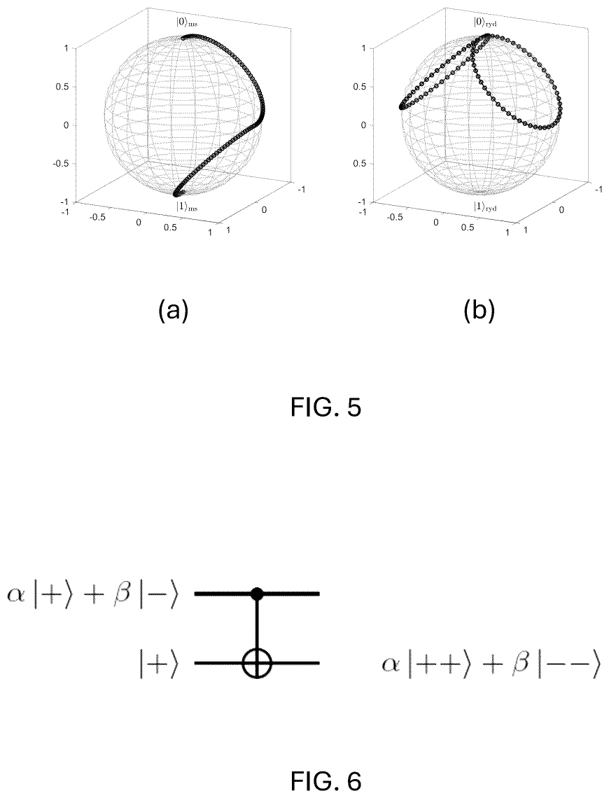

The resultant dynamics of j=1/2 is given in FIG. 5 and as the problem is only using the geometry of the Hamiltonians this same pulse is true for any spin j. FIG. 5 indicates that for the ground manifold the state |0 [symbol] goes to |1 [symbol] during the evolution whereas for the excited manifold the state remains invariant during the dynamics. The total time required for this is 4π/Ω_{rf} divided into 12 equal time-steps. However, smoother waveforms are contemplated to make this protocol more efficient.

Now the measurement of X gate is implemented given no freedom of implementing the Hadamard gate. For this one could use an ancilla-assisted gadget where information needs to be transferred from the data to ancilla and the circuit that does this is given in FIG. 6.

Now assuming that there is no error in the preparation of |+ [symbol] it is estimated whether the state is in |+ [symbol] or |− [symbol] . The first approach to measure this state is to use an adiabatic approach such that the following Hamiltonian adiabatically is given as

$$H ( s ) = - ( 1 - s ) {J}_{z}^{2} / J + {sJ}_{x} \qquad ( 39 )$$

When this transformation is performed adiabatically, depending on the cat state started with the end state as unique |+ [symbol] →|Jₓ=0 [symbol] and |− [symbol] ᵢ→|Jₓ=1 [symbol] and thus X could be measured. This transformation gives a state with an accuracy of approximately 0.98 including decoherence given by Eq. (28).

The same approach could be done using quantum control as everything is done in the ancilla and with a target isometry as

$$V = \vert + 〉 〈 {J}_{z} = J \vert + \vert - 〉 〈 {J}_{z} = - J \vert \qquad ( 40 )$$

This approach is more efficient yielding more accurate results using the control Hamiltonian given in Eq. (26).

Now the physical level gates

$$\{ {P}_{\vert 0 〉} , {P}_{\vert + 〉} , {M}_{x} , {M}_{z} , CX \} \qquad ( 41 )$$

along with Pauli gates, are used to construct the logical level universal gate set in Eq. (22). The following gate set can also be used

$$\{ {P}_{\vert 0 L 〉} , {P}_{\vert +} 〉 L , {M}_{xL} , {M}_{ZL} , {CX}_{L} , {X}_{L} \} ⋃ \{ {Toffoli}_{L} \} . \qquad ( 42 )$$

The main challenge associated with this is the implementation of the Toffoli gate without going outside the relevant error set in the spin system. However, a similar approach to CX gate and an approach for alkaline earth-like elements can be used.

Since the code satisfies the Knill-Laflamme condition for the relevant set of errors and the fault-tolerant universal gate set, the fault-tolerant syndrome extraction is identified followed by the correction of the errors fault tolerantly. There are two sets of syndromes measurements that need to be developed, one for detecting the phase errors and the other for detecting amplitude damping errors. The phase error syndromes are the same for the repetition code for phase errors

$$Sphase = \{ X 1 X 2 , X 1 X 3 \} \qquad ( 43 )$$

and a similar approach can be used for correcting this error as done for the correction of phase errors for the repetition code.

The amplitude errors correspond to the change in the value of the projection of angular momentum and the cat code encoding allows as to detect these errors to be detected by measuring the Jₓ² hence the syndromes are

$$amplitude = \{ Jz 1 , Jz , 22 , Jz , 23 \} \qquad ( 44 )$$

where the subscript {1,2,3} corresponds to the physical system. Now discussed is a detailed description of the construction one requires for finding the syndromes. The first set of syndromes involves phase errors which act according to the transformation

$${E}_{i} \vert + 〉 ∝ \vert - 〉 , \qquad ( 45 )$$

$${E}_{i} \vert - 〉 ∝ \vert + 〉 ,$$

thus interchanges the cat-states, the simplest example of this kind of noise is J_{z} and all its odd powers of it. These errors are corrected using a standard phase flip code with syndromes within the circuit
this circuit shows where one phase flip error for a general state |ψ [symbol] _{L}=α|+ [symbol] _{L}+β|− [symbol] _{L} can be corrected. The ideas can in general be extended to distance d where (d−1)/2 phase flips for d-data qubits can be corrected.

A SWAP gate may be used for overcoming amplitude damping errors. The errors which lower the total J_{z} eigenvalue is referred as amplitude damping errors. The syndrome for extracting the amplitude damping is the {J_{z,1}², J_{z,2}², J_{z,n}²} for n physical qubits. The distance of this code is 2n+1 as the error correction only depends on the extra available internal degree of freedom and is inherent the structure of this codes. However a direct QND measurement of J_{z}² for an individual qudit is not available and hence a SWAP gate is relied upon for achieving the syndrome extraction.

The circuit diagram for the SWAP gate for a qubit is

Considering the case of an arbitrary state

$$\vert ψ >= α \vert + {>}_{0} + β \vert {->}_{0} . \qquad ( 48 )$$

$$where ,$$

$$\vert \pm {>}_{k} = \frac{1}{\sqrt{2}} ( \vert {J}_{z} = j - k > + \vert {J}_{z} = - j + k > ) . \qquad ( 49 )$$

Now for the error in ε_{K} the following transformation of the state is

$$\vert ψ > \to {\sum }_{l} {p}_{l} ( α \vert + {>}_{l} + β \vert {->}_{l} ) + {q}_{l} ( α \vert {->}_{l} + β \vert + {>}_{l} ) \qquad ( 50 )$$

$$where 0 \leq {p}_{l} , {q}_{l} \leq 1 and$$

$$\begin{matrix}\vert ψ {>}_{i} = α \vert + {>}_{i} + β \vert {->}_{i} , \\ \vert ϕ {>}_{i} = α \vert {->}_{i} + β \vert + {>}_{i} .\end{matrix} \qquad ( 51 )$$

Thus for the generic action for a Kraus map from the ε_{K} for a state |ψ> gives

$${K}_{m} \vert ψ 〉 〈 ψ \vert {K}_{m}^{†} = {\sum }_{i , l} {p}_{i}^{m} {p}_{l}^{m} {\vert ψ > i < ψ \vert}_{l} + {q}_{i}^{m} {q}_{l}^{m} {\vert ϕ > i < ϕ \vert}_{l} + {\sum }_{i , l} {p}_{i}^{m} {q}_{l}^{m} {\vert ψ > i < ϕ \vert}_{l} + {q}_{i}^{m} {p}_{l}^{m} {\vert ϕ > i < ψ \vert}_{l} . \qquad ( 52 )$$

For a full set of correctable Kraus mapping

$$ρ = {\sum }_{m} {K}_{m} \vert ψ 〉 〈 ψ \vert {K}_{m}^{†} = {\sum }_{i , l} {P}_{i , l} {\vert ψ > i < ψ \vert}_{l} + {Q}_{i , l} {\vert ϕ > i < ϕ \vert}_{l} + {\sum }_{i , l} {R}_{i , l} {\vert ψ > i < ϕ \vert}_{l} + {S}_{i , l} {\vert ϕ > i < ψ \vert}_{l} . \qquad ( 53 )$$

where the following for lightening the notation is defined

$$\begin{matrix}{K}_{i , l} = {\sum }_{m} {p}_{i}^{m} {p}_{l}^{m} , \\ {Q}_{i , l} = {\sum }_{m} {q}_{i}^{m} {q}_{l}^{m} , \\ {R}_{i , l} = {\sum }_{m} {p}_{i}^{m} {q}_{l}^{m} , \\ {S}_{i , l} = {\sum }_{m} {q}_{i}^{m} {p}_{l}^{m} .\end{matrix} \qquad ( 54 )$$

Now using the fact that

$$\begin{matrix}CX ( c = 2 , t = 1 ) \vert + > \vert + {>}_{j} & = \vert + > \vert + {>}_{j} , \\ CX ( c = 2 , t = 1 ) \vert + > \vert {->}_{j} & = \vert + > \vert - {>}_{j} , \\ CX ( c = 2 , t = 1 ) \vert -> \vert + {>}_{j} & = \vert -> \vert - {>}_{j} , \\ CX ( c = 2 , t = 1 ) \vert -> \vert {->}_{j} & = \vert -> \vert + {>}_{j} ,\end{matrix} \qquad ( 55 )$$

the action of the SWAP gate may be
Thus the action of the SWAP gate on the state Φ=ρ⊗|+>₀<+|₀ yields

$$S W ( Φ ) SW = {\sum }_{i , l} {\vert + > i < + \vert}_{l} ⊗ ( {P}_{i , l} {\vert ψ > 0 < ψ \vert}_{0} + {Q}_{i , l} {\vert ϕ > 0 < ϕ \vert}_{0} ) + {\sum }_{i , l} {\vert + > i < + \vert}_{l} ⊗ ( {R}_{i , l} {\vert ψ > 0 < ϕ \vert}_{0} + {S}_{i , l} {\vert ϕ > 0 < ψ \vert}_{0} ) . \qquad ( 57 )$$

Now measuring the first system in the basis |+>ₖ the state in the second system for the outcome |+>ₖ is

$${ρ}_{2} = {P}_{k , k} {\vert ψ > 0 < ψ \vert}_{0} + {Q}_{k , k} {\vert ϕ > 0 < ϕ \vert}_{0} + {R}_{k , k} {\vert ψ > 0 < ϕ \vert}_{0} + {S}_{k , k} {\vert ϕ > 0 < ψ \vert}_{0} , \qquad ( 58 )$$

the above state can rewritten as

$${ρ}_{2} = \frac{1}{( {ρ}_{2} )} ( {P}_{k , k} {\vert ψ > 0 < ψ \vert}_{0} + {Q}_{k , k} {\vert ϕ > 0 < ϕ \vert}_{0} ) + \frac{1}{( {ρ}_{2} )} ( {R}_{k , k} {\vert ψ > 0 < ϕ \vert}_{0} + {S}_{k , k} {\vert ϕ > 0 < ψ \vert}_{0} ) , \qquad ( 59 )$$

where the pre-factor is added to preserve the trace of the density matrix. This in turn can be seen as the mixed state corresponding to the state for the dephasing channel with Kraus operators

$$\begin{matrix}{A}_{0} = \sqrt{1 - p} 1 \\ {A}_{1} = \sqrt{p} Z\end{matrix} \qquad ( 60 )$$

where p=Q_{k,k}/(ρ₂).

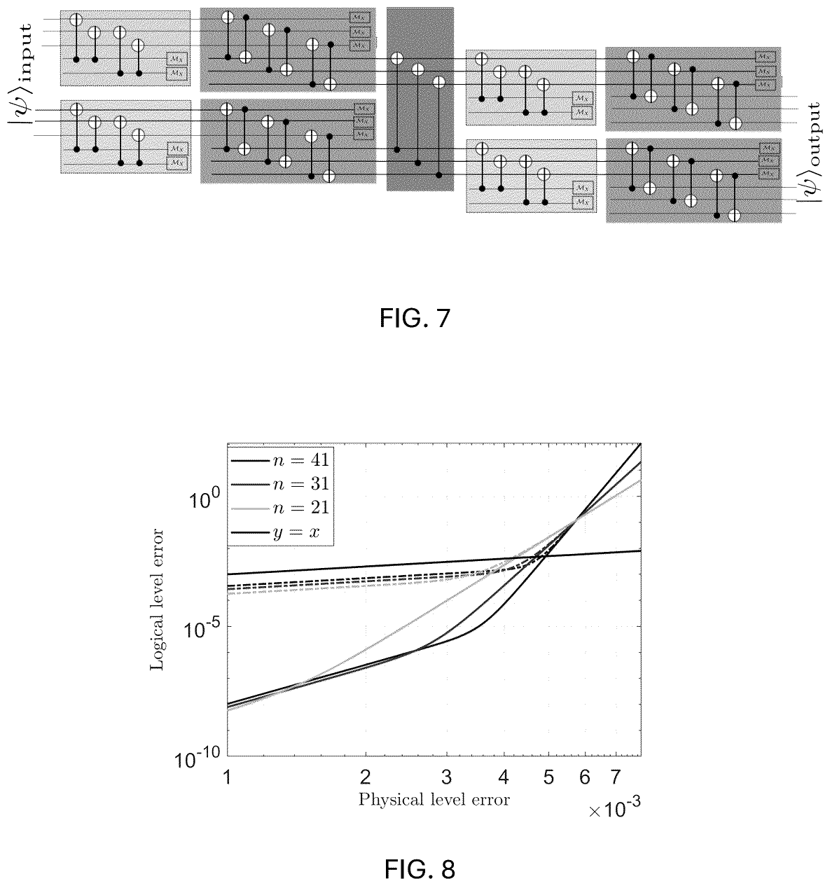

Now a fault tolerance threshold for a logical CX gate is provided. For the first layer of encoding, the logical CX gate is fundamentally hard to implement and hence upper bounding its failure probability estimates the threshold for all G_{CSS} gadgets. The logical CX gadget can be implemented with transversal CXs between two code blocks, as shown in FIG. 7.

As given in FIG. 7, there are two stages of error correction, the first one which corrects the phase error, and the second stage which corrects the amplitude error using the SWAP gate approach described above. Considering the case when r₁ blocks correct for the phase errors and r₂ blocks correct for the amplitude damping, hence for n data qubits, there is 2r number of CX gates where r=r₁+r₂.

First, consider the probability of dephasing error during the action of the logical CX. Say that the dephasing error probability for a single physical CX is ϵ. Thus, each qubit in the target and control blocks have in total at most 2r applications of physical CX. Hence the probability of dephasing error for both the target and control blocks of the CX gadget is 2rϵ. However, during the action of the CX, there is a propagation of phase error from the target to control, and hence after the action of the transversal CX block, the probability of dephasing error in the target and control block are 2rϵ+ϵ and 4rϵ+ϵ. However, a logical error has occurred for the control and the target blocks if the dephasing error has occurred on nₜₕ≤(n+1)/2 qubits. Thus, the upper bound on the logical error probability in the control and the target blocks are given as

$$\begin{matrix}{ϵ}_{t a r g e t} & \leq ( \begin{matrix}n \\ \frac{n + 1}{2}\end{matrix} ) {( 2 r ϵ + ϵ )}^{( n + 1 ) / 2} , \\ {ϵ}_{c ontrol} & \leq ( \begin{matrix}n \\ \frac{n + 1}{2}\end{matrix} ) {( 4 r ϵ + ϵ )}^{( n + 1 ) / 2} .\end{matrix} \qquad ( 61 )$$

In the next error process, the error in the measurement of the syndrome must be considered. For the phase error correction, (n−1) syndromes are measured in the control and the target blocks. This process is repeated for r₁ times and the result leads to a logical error if the syndrome is incorrect for (r₁+1)/2 times. Now for each syndrome bit two physical CX are used, and an accurate initial state preparation is needed for the ancilla and an accurate measurement of the ancilla. Thus, the probability of a dephasing error in each syndrome bit is upper bounded by 4ϵ and hence the upper bound of the logical error for this process for both the control and the target block is

$${\begin{matrix}{ϵ}_{ec} \leq 2 ( n - 1 ) ( \begin{matrix}{r}_{1} \\ \frac{{r}_{1} + 1}{2}\end{matrix} ) {( 4 ϵ )}^{\frac{{r}_{1} + 1}{2}} . & ( 62 )\end{matrix}}_{}$$

Now amplitude-damping errors are considered. One needs to find the probability of logical error in this process. Considering the s number of CX gate before the amplitude correction gadget is done. The logical error probability on the control block is given as,

$${ϵ}_{control}^{amp} \leq nr 2 F ( s , k , ϵ ) \qquad ( 63 )$$

where F(s,k,ϵ) is the probability of k+1 amplitude jumps given that k amplitude jumps can be corrected after s number of CX gates. For the target block, an additional factor of 2 is provided as the amplitude error in the control and can be transferred to the target. Similarly, the logical error probability in the control is

$${ϵ}^{a m p} target \leq 2 nr 2 F ( s , k , ϵ ) \qquad ( 64 )$$

Thus, the logical error probability of the amplitude damping error is given as

$${ϵ}^{a m p} \leq 3 {nr}_{2} F ( s , k , ϵ ) \qquad ( 65 )$$

Hence the total logical error probability is given as

$$ϵ logical = ϵ amp + ϵ ec + ϵ control + ϵ target . \qquad ( 66 )$$

Two kinds of errors in the system can be considered—the coherent error and the error occurring from an unwanted magnetic field. For this case (see FIG. 8), the logical error rate as a function of physical level error for k=4,r₂=2,s=8 calculated according to Eq. (66). The different curves show the case of the different values of n, the number of physical qubits used. The intersection of the different curves indicates the threshold for universal quantum computation. The dashed line corresponds to the case of the biased Kerr cat system for a bias of η=10⁴. Thus, in the low noise regime, the ability to correct the amplitude error significantly reduces the logical error rate compared to the previous approaches. The black line with slope=1 is shown for reference.

Now the threshold one requires for CSS-based code may be determined. The ϵ_{logical} must be lower than the accuracy threshold for a CSS code for computation with arbitrarily high accuracy to be possible.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A method for constructing a class of quantum error-correcting cat codes for continuous variable systems comprising the step of encoding a logical qubit in a spin qudit.

2. The method of claim 1 further comprising the step of creating a universal set of gates that respects the error set including the step of developing a bias-preserving CNOT gate protocol suitable for errors in the continuous variable systems.

3. The method of claim 2 wherein the developing step further comprising the step of using a Rydberg blockade for entanglement in neutral atom quantum computing.

4. The method of claim 1 further comprising the steps of:
categorizing errors as phase errors and amplitude errors;
correcting the phase errors by constructively measuring the syndrome followed by an X-gate.

5. The method of claim 4 further comprising a step of correcting the amplitude errors by using a higher dimensional nature of the logical qudit.

6. The method of claim 5 further comprising a step of coupling the qubits with ancilla, and using a swap gate to swap the states.

7. The method of claim 1 wherein the continuous variable systems are atomic spin systems.

8. A method for developing a CNOT gate that preserves the characteristic bias of noise targeted, comprising the steps of:
encoding information in a ground state;
promoting the encoded information to a metastable state;
applying a π-pulse between the metastable state and a Rydberg state, and to a target atom
transferring the encoded information from the metastable state to the Rydberg state of the target atom;
implementing an X gate in the metastable state;
transferring the encoded information and a control atom from the Rydberg state back to the metastable state; and
transferring the encoded information from the metastable state to the ground state.

9. The method of claim 8 used in a spin system.

10. The method of claim 8 wherein the promoting step further comprises the step of:
for a control atom, only the population of a |1 [symbol] state is promoted to the metastable state, and
for a target atom, both the population from a |0 [symbol] state a |1 [symbol] state are promoted to the metastable state.

11. The method of claim 8 wherein the implementing step further comprises the step of:
if the state of the control atom is in |1 [symbol] , an X gate is applied to the target atom, otherwise the target atom is unchanged.

12. The method of claim 8 wherein the transferring the encoded information from the metastable state to the Rydberg state of the target atom occurs only if the control atom is in a |0 [symbol] state from a |1Σ state.
